(19) United States
(12) Patent Application Publication
(10) Pub. No.: US 2022/0063168 A1
(43) Pub. Date: Mar. 3, 2022

(54) Multilayer system of at least three polyester layers, production thereof and use thereof

(71) Applicant: LANXESS Deutschland GmbH, Cologne (DE)

(72) Inventor: Wilhelm Laufer, Ellerstadt (DE)

(73) Assignee: LANXESS Deutschland GmbH, Cologne (DE)

(21) Appl. No.: 17/414,909

(22) PCT Filed: Dec. 16, 2019
(86) PCT No.: PCT/EP2019/085236

§ 371 Date: Jun. 16, 2021

(30) Foreign Application Priority Data
Dec. 17, 2018 (EP) 18212886.0

(51) Int. Cl. B29C 48/18; C08K 5/29; C08J 3/22; C08K 5/1515; B29C 48/08; B29C 48/15

(52) U.S. Cl. CPC B29C 48/18; C08K 5/29; C08J 3/22; B29K 2067/003; B29C 48/08; B29C 48/15; C08J 2367/02; C08K 5/1515

(57) ABSTRACT

The present invention relates to a multilayer system of at least 3 polyester layers, production thereof and use thereof for producing packaging, protective films, adhesive films, solar cells or medical materials and also solar cells produced therefrom.

The present invention relates to a multilayer system of at least 3 polyester layers, to the production thereof and to the use thereof for producing packaging, protective films, adhesive films, solar cells or medical materials and also to solar cells produced therefrom.

Polyester films have numerous possible applications, including in solar cells. A common problem is their lack of hydrolysis stability (WO2010113920). A wide variety of carbodiimides have proven advantageous as hydrolysis stabilizers for thermoplastics. However these have the disadvantage that they emit health-concerning gases during processing. The production step of the film stretching is particularly problematic since efficient air extraction apparatuses cannot be employed here.

Emission of in some cases gaseous isocyanates during the production process of the polymer films is health-hazardous and therefore necessitates the installation of comprehensive and costly air extraction apparatuses which in some cases are not industrially applicable (EP-A-0 838 500).

Polyester films comprising epoxidized plant oils as a stabilizer are described in EP-A-1 634 914 and EP-A-1 842 871. These do not suffer from the toxic degradation products typical for carbodiimides, incorporation into the polyester matrix is good given suitable choice of the oils and hydrolysis stabilization of the film is achieved, albeit only at high concentrations of the epoxide and with poorer long-term stabilization compared to the use of carbodiimides. This application in production further has the disadvantages that production intervals having an extreme propensity for gel formation often occur. When the gel level becomes too high, this results in tearoff and production of the film becomes temporarily impossible. Production must then be interrupted and the extrusion cleaned.

There was therefore a need for a system of polyester layers, in particular for films, which has a markedly reduced emission of isocyanates during processing and which exhibits very good long-term hydrolysis stabilization.

It has surprisingly now been found that a multilayer system of at least 3 polyester layers, wherein the inner polyester layer contains carbodiimides and which is surrounded on the top and bottom by further polyester layers, of which at least one contains epoxide, is hydrolysis-stable and exhibits markedly reduced isocyanate emission during processing.

The present invention provides a multilayer system of at least 3 polyester layers having the following construction:
at least one polyester layer (I) containing at least one carbodiimide,
at least one polyester layer (II) on the top of the polyester layer (I) and
at least one polyester layer (III) on the bottom of the polyester layer (I),
   wherein at least one of these polyester layers (II) or (III) contains at least one epoxide. The carbodiimides are preferably compounds of formula (I)

R¹—R²—(—N═C═N—R²—)ₙ—R¹ (I),

where
n represents an integer from 1 to 500, preferably 3 to 20, very particularly preferably 4 to 20,
   R¹ represents a radical of the series —NCO, —NCNR³—NHCONHR³, —NHCONR³R⁴ or —NHCOOR⁵, wherein R³ and R⁴ are identical or different and each independently represent a radical of the series C₁-C₁₂-alkyl, C₆-C₁₂-cycloalkyl, C₇-C₁₈-aralkyl or C₆-C₁₈-aryl and R⁵ represents a radical of the series C₁-C₂₂-alkyl, C₆-C₁₂-cycloalkyl, C₆-C₁₈-aryl or C₇-C₁₈-aralkyl, and an unsaturated alkyl radical having 2-22 carbon atoms or an alkoxypolyoxyalkylene radical,
   R² represents C₁-C₁₂-alkyl-substituted C₆-C₁₈-arylenes, C₇-C₁₈-alkylaryl-substituted C₆-C₁₈-arylenes and optionally C₁-C₁₂-alkyl-substituted arylenes bridged via C₁-C₈-alkylene groups comprising a total of 7 to 30 carbon atoms, and arylene, preferably

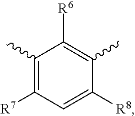

wherein R⁶, R⁷ and R⁸ each independently of one another represent methyl or ethyl, wherein each benzene ring bears only one methyl group.

Particularly preferred carbodiimides are compounds of formula (II),

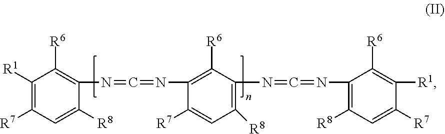

where R¹ is selected from the group of —NCO, —NHCONHR³, —NHCONR³R⁴ or —NHCOOR⁵,
wherein R³ and R⁴ are identical or different and represent a C₁-C₁₂-alkyl, C₆-C₁₂-cycloalkyl, C₇-C₁₈-aralkyl or C₆-C₁₈-aryl,
R⁵ represents C₁-C₂₂-alkyl, C₆-C₁₂-cycloalkyl, C₆-C₁₈-aryl or C₇-C₁₈-aralkyl or an unsaturated alkyl radical having 2-22 carbon atoms, preferably 12-20 carbon atoms, particularly preferably 16-18 carbon atoms, or an alkoxypolyoxyalkylene radical, and

R⁶, R⁷ and R⁸ each independently of one another represent methyl or ethyl, wherein each benzene ring bears only one methyl group and n=1 to 20.

The carbodiimide content (NCN content, measured by titration with oxalic acid) of the carbodiimides of formula (I), preferably of formula (II), employed according to the invention is preferably 2-16% by weight, preferably 4-13% by weight, particularly preferably 6-12% by weight.

The carbodiimides of formula (I), preferably of formula (II), employed according to the invention furthermore preferably have an average molar mass (Mw) to be determined by GPC viscometry of 1000-20 000 g/mol, preferably 1500-10 000 g/mol, particularly preferably 2000-5000 g/mol.

Physical, mechanical and rheological properties are often determined by polymolecularity (the ratio of weight-average molecular weight to number-average molecular weight).

This ratio is also known as polydispersity and is a measure for the width of a molar mass distribution (MMD). Preferred according to the invention are carbodiimides of formula (II) having a polydispersity D=Mw/Mn determined by gel permeation chromatography (GPC) in the range from 1.2 to 2.2, particularly preferably in the range from 1.4 to 1.8.

The carbodiimides employed according to the invention are commercially available compounds, for example the polymeric carbodiimides marketed under the name Stabaxol® from Lanxess Deutschland GmbH. However, they may also be produced for example by the processes described in EP-A-3018124.

The polyester layers (I), (II) and/or (III) are preferably layers of thermoplastic polyester. Preferred polyesters in the context of the invention are preferably polyalkyl terephthalates, preferably polyethylene terephthalate (PET), polybutylene terephthalate (PBT), polybutylene adipate terephthalates (PBAT), polytrimethylene terephthalate (PTT), and copolyesters thereof, thermoplastic polyester elastomers (TPE E), ethylene vinyl acetate (EVA), polylactic acid (PLA) and/or PLA derivatives, polybutylene succinates (PBS), polyhydroxyalkanoates (PHA) and various blends and/or polyester-based thermoplastic polyurethanes (TPU).

Particularly preferably employed independently of one another as polyester layers (I), (II) and (III) are polyalkyl terephthalates, such as especially preferably polyethylene terephthalate, polybutylene terephthalate or polybutylene adipate-terephthalates and polylactides (PLA) and copolyesters thereof.

The polyester layers (I), (II) and (III) in the multilayer system may be of the same polyester or else also of different polyesters.

The epoxides are preferably compounds based on molecules having two or more epoxy groups per molecule. These are preferably at least one epoxidized natural oil or at least one epoxidized fatty acid ester or at least one synthetic epoxidized compound. It is particularly preferable when the epoxides to be employed according to the invention have at least one terminal epoxy group of altogether at least two epoxy groups per molecule.

Preferably employed epoxides also include epoxidized natural oils or epoxidized fatty acid esters.

Preferred epoxidized natural oils are based on at least one oil from the group of olive oil, linseed oil, peanut oil, palm oil, soybean oil and cod liver oil. Particular preference is given to linseed oil or soybean oil, very particular preference to linseed oil.

Epoxidized natural oils are generally produced by the methods familiar to those skilled in the art, as disclosed for example in Angew. Chem. 2000, 112, 2292-2310.

Preferred epoxidized fatty acid esters are obtained from unsaturated aliphatic carboxylic acids having 10 to 40 carbon atoms, preferably having 16 to 22 carbon atoms, by reaction with aliphatic saturated alcohols having 2 to 40 carbon atoms, preferably 2 to 6 carbon atoms, and subsequent reaction with peroxides, preferably hydrogen peroxide.

The epoxidized fatty acid esters are preferably produced by reaction of monohydric or dihydric unsaturated carboxylic acids with aliphatic saturated alcohols. Particular preference is given to employing as the monohydric or dihydric carboxylic acid at least one carboxylic acid from the group of pelargonic acid, palmitic acid, lauric acid, margaric acid, dodecanedioic acid, behenic acid, stearic acid, capric acid, montanic acid, linoleic acid, linolenic acid and oleic acid and subsequent reaction with peroxides, preferably hydrogen peroxide.

Aliphatic saturated alcohols preferably to be employed are 1- to 4-hydric alcohols selected from the group of n-butanol, n-octanol, stearyl alcohol, ethylene glycol, propylene glycol, neopentyl glycol, pentaerythritol and glycerol. Glycerol is especially preferred.

Mixtures of different epoxidized fatty acid esters and/or epoxidized natural oils may also be employed.

However it is likewise possible to employ synthetic epoxidized compounds including for example aromatic epoxidized polymers or condensation products. These are produced for example by reaction of aromatic alcohols with formaldehyde, which are subsequent reacted with peroxides. Employable aromatic alcohols include in particular mononuclear or polynuclear phenols.

Preferred mononuclear phenols are resorcinol or hydroquinone.

Preferred polynuclear phenols are bis(4-hydroxyphenyl)methane, 2,2-bis(4-hydroxyphenyl)propane, 2,2-bis(3,5-dibromo-4-hydroxyphenyl)propane or 4,4′-dihydroxydiphenylsulfone.

Preferred condensation products of phenols with formaldehyde are phenol novolacs.

In a further preferred embodiment of the invention aromatic epoxy compounds having two terminal epoxy functions are employed. These are preferably an oligomeric reaction product of bisphenol A with epichlorohydrin having an average molecular weight determined according to EN ISO 10927 in the range from 900 to 1200 g/mol and an epoxy index determined according to ISO 3001 in the range from 450 to 600 grams per equivalent. It is particularly preferable to employ the reaction product of formula (III) from the reaction of bisphenol A with epichlorohydrin,

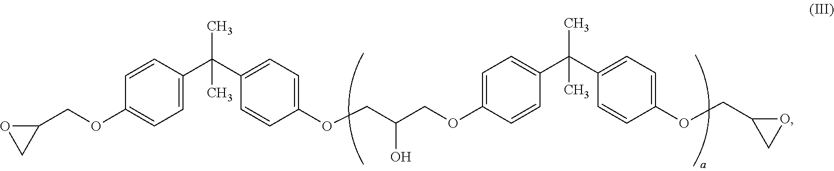

wherein a represents an average number from 0 to 10, preferably 1 to 8, particularly preferably 1 to 6, very particularly preferably 2 to 3.

The epoxides are preferably produced by a process according to US2002/0128428 A1 and then have an average molecular weight according to EN ISO 10927 of 900 to 1200 g/mol which in formula (III) corresponds to an a in the range from 2 to 3 with an epoxy index determined according to ISO 3001 of 450 to 600 grams per equivalent.

It is preferable to employ synthetic epoxy compounds having a Mettler softening point according to DIN 51920 in the range from 0 to 150° C., particularly preferably 50° C. to 120° C., very particularly preferably in the range from 60° C. to 110° C. and in particular in the range from 75° C. to 95° C. The Mettler softening point is the temperature at which the sample flows out of a cylindrical nipple having an outflow opening of 6.35 mm in diameter, thus interrupting a light gate which lies 19 mm below. To this end, the sample is heated in air under constant conditions.

It is preferable to employ synthetic epoxy compounds having an average epoxide equivalent weight (EEW, grams of resin containing one mole of epoxidically bonded oxygen) via titration according to DIN 16945 of 160 to 2000 g/eq, preferably 250 to 1200 g/eq, particularly preferably 350 to 1000 g/eq and especially preferably in the range from 450 to 800 g/eq.

Especially preferably employed as compound of formula (III) is a poly(bisphenol A-co-epichlorohydrin) [CAS No. 25068-38-6] preferably having a number average molecular weight (Mₙ) to be determined by MALDI-TOF mass spectrometry by matrix-assisted laser desorption/ionization time-of-flight mass spectrometry according to EN ISO 10927 in the range from 600 to 1800 g/mol, obtainable as Epilox® from Leuna Harze GmbH, Leuna.

Further preferred epoxide compounds having at least 2 epoxide functions are commercially available under the name Joncryl® from BASF AG, in particular Joncryl® 4368, which contain the following units in any combination

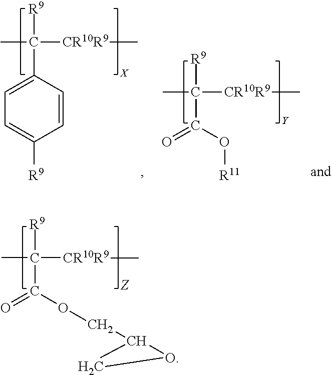

In the units shown R⁹, R¹⁹ each independently of one another represent H or C₁-C₈-alkyl, R¹¹ represents C₁-C₈-alkyl, x and y independently of one another represent an average number from 1 to 20 and z represents an average number from 2 to 20. The chain terminus is formed by end groups R* which independently of one another represent H or C₁-C₈-alkyl.

The epoxide preferably conforms to formula (IV)

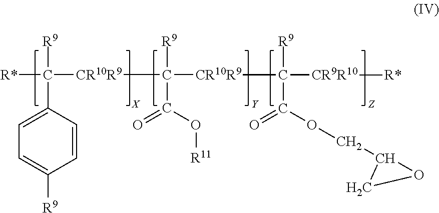

wherein R⁹, R¹⁰ each independently of one another represent H or C₁-C₈-alkyl, R¹¹ represents C₁-C₈-alkyl, x and y independently of one another represent an average number from 1 to 20 and z represents an average number from 2 to 20, wherein the end groups R* independently of one another represent H or C₁-C₈-alkyl.

In a preferred or alternative embodiment epoxidized fatty acid esters of glycerol, in particular epoxidized vegetable oils, are employed as epoxides. These are obtained by epoxidation of the reactive olefin groups of triglycerides of unsaturated fatty acids. Epoxidized fatty acid esters of glycerol may be produced starting from unsaturated fatty acid esters of glycerol, preferably from vegetable oils and organic peroxycarboxylic acids (Prilezhaev reaction). Processes for producing epoxidized natural oils are described for example in Smith, March, March's Advanced Organic Chemistry, 5^{th} edition, Wiley-Interscience, New York, 2001. Preferred epoxidized fatty acid esters of glycerol are epoxidized natural oils, particularly preferably epoxidized soybean oil [CAS No. 8013-07-8].

The proportion of the polyester layer (I) in the multilayer system according to the invention is generally between 10% by weight and 99% by weight, preferably between 30% by weight and 90% by weight, and the proportion of the polyester layer (I) in the multilayer system according to the invention is particularly preferably between 50% by weight to 70% by weight based on the total weight of the multilayer system.

It is preferable when the polyester layers (II) and (III) contain an epoxide. It is further preferable when the polyester layers (II) and (III) contain no carbodiimide.

In a preferred embodiment of the invention the amount of carbodiimide in the polyester layer (I) is 0.2% to 3% by weight, preferably 0.5% to 1.5% by weight, based on the polyester layer (I).

In a further preferred embodiment of the invention the amount of epoxides in at least one of the polyester films (II) and/or (III) is 0.1% to 6% by weight, preferably 0.5% to 4% by weight, based on the polyester layer (II) or polyester layer (III).

In a preferred embodiment of the invention the weight fraction of the carbodiimide-containing polyester layer (I) is 70% by weight to 95% by weight based on the total weight of the multilayer system.

In a further preferred embodiment of the invention the thickness of the polyester layer is preferably between 11 and 500 micrometres and particularly preferably between 24 and 300 micrometres.

In multilayered embodiments of the carbodiimide-containing layer the sum of the thicknesses of the carbodiimide-containing layers is typically more than 10 micrometres and less than 500 micrometres and particularly preferably more than 40 micrometres and less than 300 micrometres.

Polyester layer (II) and/or polyester layer (III) are preferably thin to impair the hydrolysis stability of the overall film as little as possible, i.e. these layers are preferably in each case thinner than 5 micrometres, particularly preferably thinner than 3 micrometres and ideally thinner than 0.8 micrometres. However, it has proven advantageous when polyester layer (II) and/or polyester layer (III) are not thinner than 0.1 micrometres.

The present invention also further provides a process for producing the multilayer system, characterized in that the carbodiimide-containing polyester layer (I) and the optionally epoxide-containing polyester layers (II) and (III) are coextruded to afford a multilayer system.

Coextrusion processes are known from the prior art. It is thus also possible to employ the customary temperatures and pressures employed in the context of coextrusion in the production process of the multilayer system according to the invention. The temperatures are preferably 200° C. to 300° C.

This process is preferably carried out in such a way that the multilayer system according to the invention is produced from the polyester layer (I) and polyester layer (II) and (III) by coextrusion using at least two extruders, optionally with addition of adhesion promoters.

Especially during extrusion of the polyester layer (I) decomposition of the carbodiimide may bring about formation of isocyanates. In this process it is preferable for the extrusion to employ a slot die to produce the polyester layer. In a preferred variant of the production process according to the invention air extraction apparatuses are attached to the slot die.

To produce the polyester layer (I) the polyester is admixed with the carbodiimide and extruded.

To produce the polyester layers (II) and (III) at least one of the polyesters is admixed with the epoxide during extrusion. Commonly used metering systems may be used therefor.

The polyester layer (I) is then extruded with polyester layers (II) and (III) in such a way that the polyester layer (I) is surrounded by the polyester layers (II) and (III) on the opposite side.

The process for producing the layers of the multilayer system according to the invention is preferably carried out such that the corresponding polyester melts modified with the carbodiimide of formula (I) for polyester layer (I) and modified with epoxide for the polyester layer (II) and/or (III) are extruded through a flat film die, the thus-obtained layer is hauled off and chilled as a largely amorphous pre-layer on one or more rollers, preferably a cooling roller, for consolidation, the layer is then optionally reheated and preferably biaxially stretched (oriented) and the biaxially stretched layer is subjected to heat setting. It is thus preferably obtained in film form. It has proven advantageous when temperatures of 295° C. are not exceeded in the region of the extrusion.

It is particularly advantageous when the region of the die and especially the region of the die lip and the region proximal thereto is no warmer than 290° C., preferably no warmer than 285° C. and particularly preferably no warmer than 275° C. The higher the temperature the higher the thermal stress on the stabilizers and thus the higher the propensity for gel formation.

Biaxial stretching is generally performed sequentially. This preferably comprises stretching initially in the longitudinal direction (i.e. in the machine direction=MD) and subsequently in the transverse direction (i.e. perpendicular to the machine direction=TD). This results in orientation of the molecular chains. The stretching in the longitudinal direction is performable using two rollers running at different speeds according to the desired stretching ratio.

The temperature at which the stretching is performed may vary within a relatively wide range and according to the desired properties of the layer. The longitudinal stretching and also the transverse stretching are generally carried out at Tg+10° C. to Tg+60° C. (Tg=glass transition temperature of the layer). The longitudinal stretching ratio is generally in the range from 2.0:1 to 6:1, preferably 3:1 to 4.5:1. The transverse stretching ratio is generally in the range from 2:1 to 5:1, preferably 3:1 to 4.5:1, and that of an optionally performed second longitudinal and transverse stretching is 1.1:1 to 5:1.

Longitudinal stretching may optionally be performed simultaneously with transverse stretching (simultaneous stretching). It has proven particularly advantageous when the stretching ratio in the longitudinal and transverse directions is in each case greater than 3.0.

In the subsequent heat setting the layer is preferably held for about 0.1 to 10 s at a temperature of 150° C. to 260° C., preferably 200° C. to 245° C. Subsequently, or commencing during heat setting, the layer is relaxed by 0% to 15%, preferably by 1.5% to 8%, in the transverse direction and optionally also in the longitudinal direction and the layer is then cooled and wound up in customary fashion.

The present invention also further provides for the use of the multilayer system according to the invention for producing packaging, protective films, such as preferably for solar cells or in the medical sector, or for producing adhesive films.

The multilayer system according to the invention is preferably used for producing protective films for solar cells. The present invention thus likewise encompasses solar cells containing the multilayer system.

In the present invention the multilayer system according to the invention is used as backsheet film in solar cells. The multilayer system according to the invention is employable in all solar cells known from the prior art.

Production of the solar cell is carried out according to the processes described in the prior art, starting from the standard methods for producing silicon via casting processes, the Bridgeman process, EFG (edge-defined film-fed growth) processes or the Czochralski process and subsequent production of the Si wafer and lamination of the abovementioned material layers, wherein the multilayer system according to the invention is employed instead of the backsheet film used as standard.

The scope of the invention encompasses all hereinabove and hereinbelow recited general or preferred definitions of radicals, indices, parameters and elucidations among themselves, i.e. including between the respective ranges and preferred ranges in any desired combination.

The multilayer system according to the invention makes it possible for the first time to provide a hydrolysis-stabilized polyester multilayer system.

The examples which follow serve to elucidate the invention without any limiting effect.

### EXAMPLES

### Example 1

Tests were carried out on:
1) Carbodiimide A: a polymeric carbodiimide having an NCN content of about 11.8% by weight, D=about 1.8 and Mw=2300 g/mol of formula (II) where n=about 3-4, R⁶, R⁷, R⁸ each independently represent methyl or ethyl, wherein each benzene ring bears only one methyl group and R¹=—NHCOOR⁵ and R⁵=cyclohexyl.
2) Carbodiimide masterbatch B: Polyethylene terephthalate (PET) obtainable from Invista Deutschland GmbH having an intrinsic viscosity of 0.8 which is admixed with 10% by weight of carbodiimide A and extruded.
3) Stabilizer C: Epoxide of formula (III) where n=in the range of 2-3 having an epoxide equivalent weight (DIN 16945) of 500 to 700 g/eq and a softening point (Mettler, DIN 51920) between 75° C. and 90° C. [CAS No 25068-38-6].
4) Polyethylene terephthalate (PET) obtainable from Invista Deutschland GmbH having an intrinsic viscosity of 0.8.

The multilayer systems recited in table 1 were produced using an extruder for the inner polyester layer (I) and a co-extruder for the outer polyester layers (II) and (III) using polyethylene terephthalate as the polyester. An air extraction means was attached to the slot die. Table 1 summarizes the usage amounts and also the results of the qualitative emissions measurement in the stretching region using standardized indicator tubes for isocyanates (measurement duration about 30 min.) and the hydrolysis stability of the PET multilayer films.

### Measurement of Hydrolysis Stability

For the hydrolysis test the layers were stored in steam at a temperature of 120° C. for 24 hours and their breaking elongation is measured after 0 and 24 hours.

The values for hydrolysis stability reported in table 1 derive from the following calculation: Breaking elongation [%]=(breaking elongation after 24 hours/breaking elongation after 0 hours)×100.

TABLE 1

| | | | | Hydrolysis |
|---|---|---|---|---|
| | | Composition | | stability |
| | Composition | of polyester | Isocy- | (breaking |
| | of polyester | layer (II) | anate | elongation |
| | layer (I) | and (III) | test | in %) |
| Comparative | 100% by wt. | 100% by wt. | negative | 38 |
| example | PET | PET | | |
| Comparative | 15% by wt. | 15% by wt. | positive | 95 |
| example | carbodiimide | carbodiimide | | |
| analogous to | masterbatch B/ | masterbatch B/ | | |
| EP0838500 | 85% by wt. PET | 85% by wt. PET | | |
| Comparative | 4% by weight | 4% by weight | negative | 36 |
| example | stabilizer C, | stabilizer C, | | |
| analogous to | 96% by wt. PET | 96% by wt. PET | | |
| EP1634914 | | | | |
| Inventive | 15% by wt. | 0.5% by wt. | negative | 91 |
| example | carbodiimide | stabilizer C, | | |
| | masterbatch B/ | 99.5% by wt. | | |
| | 85% by wt. PET | PET | | |
| Comparative | 15% by wt. | 100% by wt. | positive | test values |
| example | carbodiimide | PET | | highly |
| | masterbatch B/ | | | scattered. |
| | 85% by wt. PET | | | |

The inventive example demonstrates the positive effect of the multilayer system according to the invention since said system shows no outgassing of isocyanate whatsoever coupled with good hydrolysis stability.

1. A multilayer system of at least 3 polyester layers having the following construction:
at least one polyester layer (I) containing at least one carbodiimide,
at least one polyester layer (II) on the top of the polyester layer (I) and
at least one polyester layer (III) on the bottom of the polyester layer (I), characterized in that at least one of these polyester layers (II) or (III) contains at least one epoxide,
wherein the amount of carbodiimide in the polyester layer (I) is 0.2% to 3% by weight based on the polyester layer (I).

2. The multilayer system according to claim 1, characterized in that the carbodiimide is a compound of formula (I)
R¹—R²—(—N═C═N—R²—)ₙ—R¹ (I),
where
n represents an integer from 1 to 500,
R¹ represents a radical of the series —NCO, —NCNR³, —NHCONHR³, —NHCONR³R⁴ or —NHCOOR⁵,
wherein R³ and R⁴ are identical or different and each independently represent a radical of the series C₁-C₁₂-alkyl, C₆-C₁₂-cycloalkyl, C₇-C₁₈-aralkyl or C₆-C₁₈-aryl and R⁵ represents a radical of the series C₁-C₂₂-alkyl, C₆-C₁₂-cycloalkyl, C₆-C₁₈-aryl or C₇-C₁₈-aralkyl, or an unsaturated alkyl radical having 2-22 carbon atoms or an alkoxypolyoxyalkylene radical,
R² represents C₁-C₁₂-alkyl-substituted C₆-C₁₈-arylenes, C₇-C₁₈-alkylaryl-substituted C₆-C₁₈-arylenes or optionally C₁-C₁₂-alkyl-substituted arylenes bridged via C₁-C₈-alkylene groups comprising a total of 7 to 30 carbon atoms or arylene.

3. The multilayer system according to claim 1, wherein the carbodiimides are compounds of formula (II), 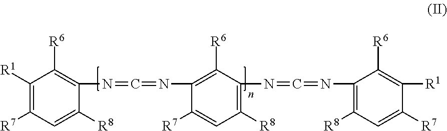
where R¹ is selected from the group of —NCO, —NHCONHR³, —NHCONR³R⁴ or —NHCOOR⁵,
wherein R³ and R⁴ are identical or different and represent C₁-C₁₂-alkyl, C₆-C₁₂-cycloalkyl, C₇-C₁₈-aralkyl or C₆-C₁₈-aryl,
R⁵ represents C₁-C₂₂-alkyl, C₆-C₁₂-cycloalkyl, C₆-C₁₈-aryl or C₇-C₁₈-aralkyl or an unsaturated alkyl radical having 2-22 carbon atoms, or an alkoxypolyoxyalkylene radical, and
R⁶, R⁷ and R⁸ each independently of one another represent methyl or ethyl, wherein each benzene ring bears only one methyl group and n=1 to 20.

4. The multilayer system according to claim 1, wherein the polyester layer (I), (II) and/or (Ill) is thermoplastic polyester.

5. The multilayer system according to claim 1, wherein the polyester is selected from polyethylene terephthalate (PET), polybutylene terephthalate (PBT), polybutylene adipate terephthalate (PBAT), polytrimethylene terephthalate (PTT) and copolyesters, thermoplastic polyester elastomers (TPE E), ethylene vinyl acetate (EVA), polylactic acid (PLA) and/or PLA derivatives, polybutylene succinates (PBS), polyhydroxyalkanoates (PHA), and various blends and/or polyester-based thermoplastic polyurethanes.

6. The multilayer system according to claim 1, wherein the epoxides are compounds based on molecules having two or more epoxy groups per molecule.

7. The multilayer system according to claim 1, wherein the epoxides are a compound of formula (IV) 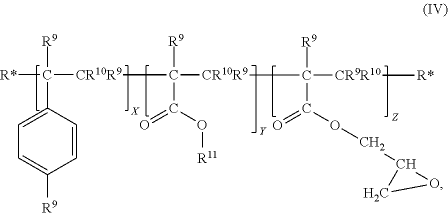
wherein R⁹, R¹⁰ each independently of one another represent H or C₁-C₈-alkyl, R¹¹ represents C₁-C₈-alkyl, x and y independently of one another represent an average number of 1 to 20 and z represents an average number of 2 to 20, wherein the end groups R* independently of one another represent H or C₁-C₈-alkyl.

8. The multilayer system according to claim 1, wherein the amount of carbodiimide in the polyester layer (I) is 0.5% to 1.5% by weight based on the polyester layer (I).

9. The multilayer system according to claim 1, wherein the amount of epoxides in at least one of the polyester layers (II) or (III) is 0.1% to 6% by weight based on the polyester layer (II) or (III).

10. The multilayer system according to claim 1, wherein the weight fraction of the carbodiimide-containing polyester layer (I) is 70% by weight to 90% by weight based on the total weight of the multilayer system.

11. Process for producing a multilayer system according to claim 1, comprising coextruding the carbodiimide-containing polyester layer (I) and the polyester layers (II) and (III) to afford a multilayer system.

12. The process according to claim 11, wherein the polyester layer (I) is extruded and the polyester layers (II) and (III) are extruded around this polyester layer (I) by coextrusion.

13. (canceled)

14. A solar cell comprising at least one multilayer system according to claim 1.

15. The multilayer system according to claim 2, wherein n in formula (I) represents an integer from 3 to 20.

16. The multilayer system according to claim 2, wherein R² represents 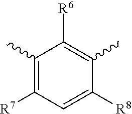
wherein R⁶, R⁷ and R⁸ each independently of one another represent methyl or ethyl, wherein each benzene ring bears only one methyl group.

17. The multilayer system according to claim 3, wherein R⁵ represents an unsaturated alkyl radical having 12-20 carbon atoms.
